(19) United States
(12) Patent Application Publication
(10) Pub. No.: US 2025/0304170 A1
(43) Pub. Date: Oct. 2, 2025

(54) VEHICLE CROSSMEMBER AND FLOOR STRUCTURE

(71) Applicant: Shape Corp., Grand Haven, MI (US)

(72) Inventors: Xinda Huang, Kunshan (CN); Matthew Kuipers, Holland, MI (US); Sharad Suryakant Pawar, Maharashtra (IN)

(21) Appl. No.: 19/091,122

(22) Filed: Mar. 26, 2025

Related U.S. Application Data
(60) Provisional application No. 63/569,997, filed on Mar. 26, 2024.

(51) Int. Cl. B62D 21/03; B62D 25/20

(52) U.S. Cl. CPC B62D 21/03; B62D 25/20

(57) ABSTRACT

A crossmember for a vehicle floor structure includes a roll-formed beam having an elongated hollow body formed from a metal sheet. The beam is configured to span laterally over a floor panel with opposing ends of the beam coupled to longitudinal members that extend along sides of the floor panel. The beam includes a cross-sectional shape taken transverse to the length of the beam and extending consistently along the length between the opposing ends of the beam. The beam has a first hollow section and a second hollow section extending along the length of the beam, where the first and second hollow sections are interconnected by a narrowed section of the cross-sectional shape. Edges of the metal sheet are welded together along the length of the beam at the narrowed section of the cross-sectional shape.

### CROSS-REFERENCE TO RELATED APPLICATION

This application claims the benefit and priority under 35 U.S.C. § 119(e) of U.S. provisional application Ser. No. 63/569,997, filed on Mar. 26, 2024, the content of which is incorporated herein by reference in its entirety.

### TECHNICAL FIELD

The present disclosure relates generally to vehicle beams and structures, and more specifically to vehicle crossmembers and related floor structures, assemblies, sub-assemblies, and the like.

### BACKGROUND

It is generally understood that vehicle frames and body structures are designed undergo and absorb certain levels of impact forces, such as to prevent distances of inboard intrusion into the vehicle in accordance with insurance requirements and other regulatory and legal requirements. Battery storage in electric and hybrid electric vehicles make it more desirable to reduce side impact intrusion distance in order to maximize available battery storage volume, such as in the battery trays below the vehicle floor. Side impacts to a vehicle are commonly tested with side pole impact testing, which direct significant side impact forces to the vehicle. Vehicle frames primarily absorb these side impacts at the rocker sections that run longitudinally along the lower outboard portions of the vehicle frame.

### SUMMARY

This disclosure provides a vehicle structural beam with an elongated hollow body that has a cross-sectional shape extending continuously along the length of the tubular beam. The cross-sectional shape is designed to carry impact forces delivered to the vehicle along longitudinal load paths, such as side impact forces carried by a crossmember for a vehicle floor assembly or vehicle battery tray. The crossmember beam is roll formed from a metal sheet to define a first hollow section and a second hollow section extending adjacent to each other and divided by a narrowed section along the length of the beam. At the narrowed section of the cross-sectional shape, the upper wall and the lower wall of the beam are attached or in closer proximity relative to the first and second hollow sections. To enclose the hollow body, the edges of the metal sheet are welded together along the length of the beam at a narrowed section of the cross-sectional shape. The weld at the narrowed section stabilizes the cross-sectional shape, which is otherwise formed from the metal sheet devoid of additional edge welds.

According to one aspect of the disclosure, a crossmember for a vehicle floor structure includes a roll-formed beam having an elongated hollow body formed from a metal sheet. The beam is configured to span laterally over a floor panel with opposing ends of the beam coupled to longitudinal members that extend along sides of the floor panel. The beam includes a cross-sectional shape taken transverse to a length of the beam and extending consistently along the length between the opposing ends of the beam. The beam has a first hollow section and a second hollow section extending along the length of the beam, where the first and second hollow sections are interconnected by a narrowed section of the cross-sectional shape. Edges of the metal sheet are welded together along the length of the beam at the narrowed section of the cross-sectional shape.

In some implementations, the beam includes an upper wall and a lower wall extending along opposing sides of the first and second hollow sections. The upper and lower walls may each include at least two bends along the length of the beam that direct the respective upper and lower walls inward at the narrowed section. The edges of the metal sheet may be attached at the upper wall of the beam. In other examples, the edges of the metal sheet are attached at the lower wall of the beam. The upper wall and the lower wall, in some examples, are attached at the narrowed section of the cross-sectional shape. A weld may attach the edges of the metal sheet together and simultaneously attach the upper and lower walls together. In other examples, the upper wall and the lower wall are spaced apart at the narrowed section of the cross-sectional shape.

In some examples, the first hollow section and/or the second hollow section may include a stiffening channel disposed along the length of the beam. The first and second hollow sections of the beam may, in some examples, be substantially mirror images across the narrowed section of the cross-sectional shape. In some examples, a planar extent of the upper wall at the first and second hollow sections is angled relative to a planar extent of the lower wall at first and second hollow sections.

According to another aspect of the disclosure, a vehicle floor assembly includes a floor panel and a crossmember beam disposed at and extending over an upper surface of the floor panel. The crossmember beam comprises an elongated hollow body formed from a metal sheet and defining a cross-sectional shape that extends continuously along a linear length of the crossmember beam. The crossmember beam includes a first hollow section and a second hollow section extending adjacent to each other along the length of the beam. The first and second hollow sections are interconnected by a narrowed section of the cross-sectional shape. Edges of the metal sheet are welded together along the length of the beam at the narrowed section of the cross-sectional shape.

The vehicle floor assembly, in some examples, includes a pair of rocker sections extending longitudinally along outboard edges of the floor panel. The crossmember beam may extend laterally across the vehicle floor between the pair of rocker sections, such that the crossmember beam may define a lateral load path between the pair of rocker sections.

In some examples, the vehicle floor assembly includes a second crossmember attached and spanning between the pair of rocker members at a longitudinally spaced distance from the first crossmember. The vehicle floor assembly may also include a seat assembly coupled at and supported by the crossmembers.

In some examples, the metal sheet of the crossmember beam comprises a martensitic steel with a tensile strength of at least 980 MPa, or more preferably at least 1,500 MPa.

According to a further aspect of the disclosure, a crossmember for a vehicle floor structure includes a roll-formed beam having an elongated hollow body formed from a metal sheet and configured to span laterally over a floor panel. The beam includes a cross-sectional shape taken transverse to a length of the beam and extending consistently along the length between the opposing ends of the beam. The beam has a first hollow section and a second hollow section extending along the length of the beam, where the first and second hollow sections are interconnected by a narrowed section of the cross-sectional shape. The edges of the metal sheet are welded together at a seam extending along the length of the beam. The seam has an induction weld formed continuously between the edges of the metal sheet to align the inner and outer surfaces of the metal sheet on opposing sides of the seam. In some examples, the edges of the metal sheet are attached and form the seam at the upper wall, the lower wall, or a side wall of the beam that extends between the upper and lower walls.

Each of the above independent aspects of the present disclosure, and those aspects described in the detailed description below, may include any of the features, options, and possibilities set out in the present disclosure and figures, including those under the other independent aspects, and may also include any combination of any of the features, options, and possibilities set out in the present disclosure and figures.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is a perspective view of a vehicle having a framework architecture.

FIG. 2 is a side elevation view of a vehicle showing a floor assembly.

FIG. 3 is a top plan view of the floor assembly shown in FIG. 2.

FIG. 4 is a cross-sectional view of a crossmember taken at line A-A in FIG. 3.

FIGS. 5-13 are cross-sectional views of additional examples of a crossmember.

Like reference numerals indicate like parts throughout the drawings.

### DETAILED DESCRIPTION

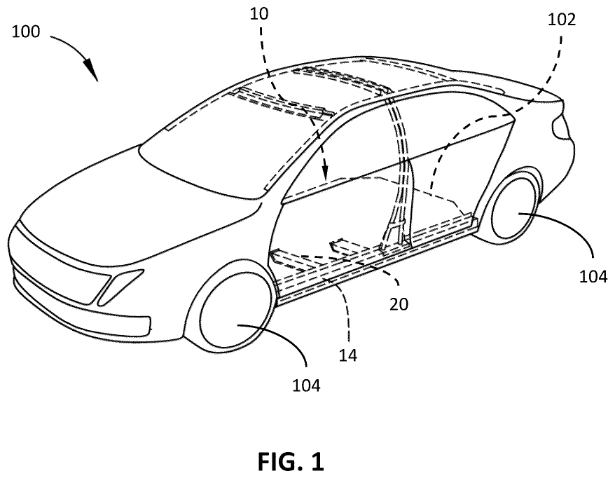

Referring now to the drawings and the illustrative examples depicted therein, a floor assembly 10 for a vehicle 100, such as shown in FIGS. 1-3, has a floor panel 12 and a pair of rocker sections 14 disposed longitudinally along sides of the floor panel 12. The floor assembly 10 or vehicle structure may also include stamped features formed in the floor panel 12 between the longitudinal members or rocker sections 14. In additional examples, a central tunnel may protrude longitudinally along a center of the floor, such as for spanning over or partially housing vehicle drive train and exhaust system components of an internal combustion engine (ICE) vehicle. It is also contemplated that the central tunnel may house or partially enclose wire harnesses, coolant lines, or electrical components, such as those related for an electric vehicle.

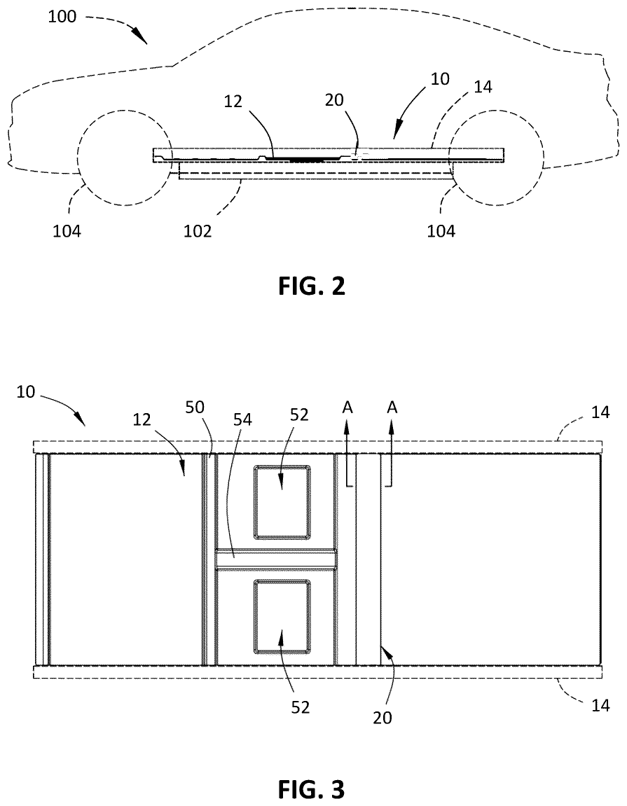

As shown in the example provided in FIG. 2, the vehicle 100 may include a battery tray 102 mounted generally inboard from outer sills of the rocker sections 14 and below the floor panel 12 of the floor assembly 10. The battery tray 102 encloses a battery or batteries that are at least partially used to operate a propulsion system of the vehicle 100, such as a traction battery or battery modules or the like. The battery tray 102 may be generally between the front and rear wheels 104 of the vehicle 100 to distribute the battery weight and establish a low center of gravity for the vehicle. The vehicle for purposes of the disclosure may be any type of land motor vehicle, such as a car, truck, bus, van, sport utility vehicle, or the like, including those used for passenger travel, cargo shipping, or any other personal, governmental, or commercial purposes.

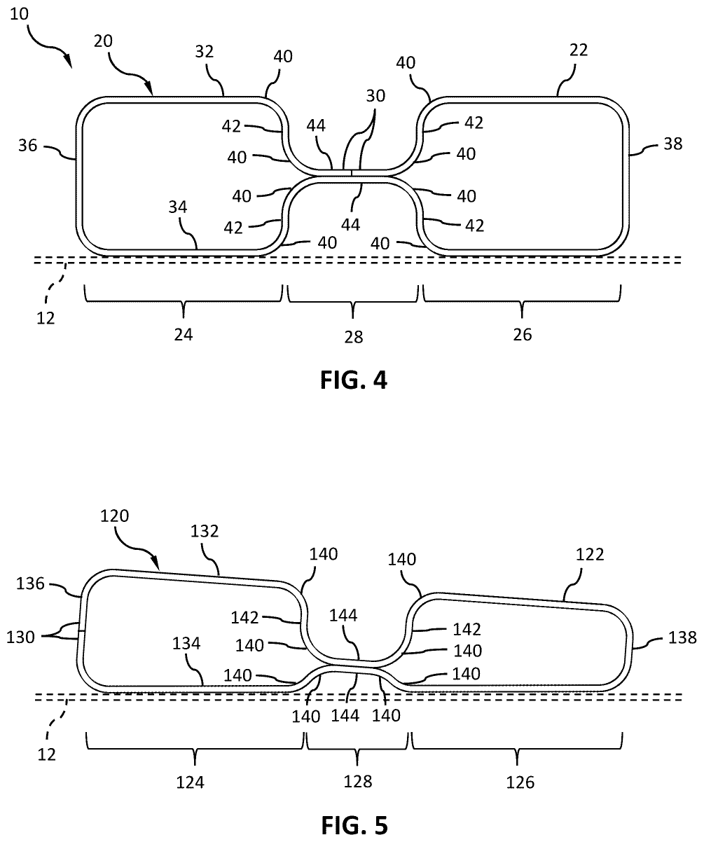

The floor assembly 10, such as shown in FIGS. 2 and 3, includes at least one structural beam, such as shown as a crossmember 20. It is contemplated that in other examples, additional crossmembers may be provided between the rocker sections, with or without the crossmember attachment configuration and structure shown in FIGS. 2 and 3. The crossmember 20 is disposed at and extends over an upper surface of the floor panel 12, such as shown spanning laterally across the top side of the vehicle floor panel 12. In additional examples, the crossmember 20 may be integrated into the battery tray 102 as an internal crossmember thereof. The crossmember 20 includes a tubular beam that has a cross-sectional shape extending continuously along the length of the tubular beam, such as shown in FIG. 4 or in additional examples shown in FIGS. 5-13.

As shown in FIG. 3, the crossmember 20 is coupled to and spans between the rocker sections 14, such as to define a lateral load path between the rocker sections 14 for transmitting side impact loads or forces laterally across the floor panel 12. By doing so, inboard deformation from side impacts is reduced, such as to prevent impact intrusion interference with the battery tray. The rocker sections 14 are shown as exemplary configurations, which may be implemented as inner and outer sills, panels, or other longitudinal frame components or portions thereof. As shown in FIG. 3, the crossmember 20 couples with the rocker sections, such as to provide direct or indirect attachment, such as with the use of direct welding, adhesive, fasteners, and/or brackets or the like. For example, the crossmember may include a pair of mounting brackets that are attached between the opposing ends of the tubular beam and inboard surfaces of the rocker sections. Such mounting brackets may be formed or stamped with different shapes for configurations, such as to mount along sides or span over the crossmember.

As shown in FIGS. 2-4, the crossmember 20 spans laterally in the vehicle and is disposed over the floor panel 12 with a bottom surface of the crossmember 20 supported on the upper surface of floor panel 12. The crossmember 20 is attached to the metal sheet of the floor panel 12, such as with welding, fasteners, adhesive, or the like. The welding 22 of the crossmember 20 to the floor panel 12 increases rigidity and bending strength of each other, such as to allow the crossmember to be formed with lighter and higher gauge metal sheet material. Also, the welding of the crossmember to the floor panel can provide a structural or support beam configured to mounting a seat assembly to the vehicle floor.

As shown in FIGS. 2 and 3, the floor panel 12 includes a steel sheet with stamped stiffening features and mounting locators. The front area of the floor panel 12 includes foot wells located forward a front lateral ridge 50 that is used to mount front portions of the seat assemblies. The rear portions of seat assemblies are mounted at or near the crossmember 20, such that two square recessed areas 52 are formed between the crossmember 20 and the front lateral ridge 50 for providing space for seat assembly components, wire harnesses, and air circulation below the respective seat assemblies. Also, a longitudinal ridge 54 is formed to extending between the front lateral ridge 50 and the crossmember 20 to provide additional longitudinal stiffness for supporting the seat assemblies. The metal sheet of the floor panel may be a martensitic steel, such as with a thickness of 2 mm and a tensile strength of at least 980 MPa, and in some examples the floor panel may be divided into sections or separate floor panels.

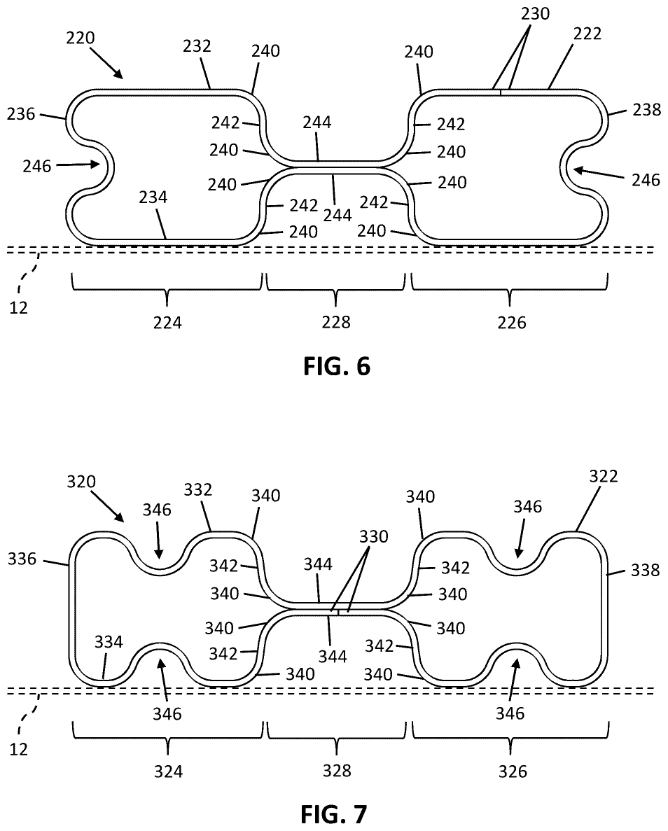

As shown in FIG. 4, the crossmember 20 is a roll-formed beam having an elongated hollow body formed from a metal sheet 22. The cross-sectional shape taken transverse to a length of the beam has a first hollow section 24 and a second hollow section 26 extending along the length of the beam. The first and second hollow sections 24, 26 are interconnected by a narrowed section 28 of the cross-sectional shape. As shown in FIG. 4, edges 30 of the metal sheet 22 are welded together along the length of the beam at the narrowed section 28 of the cross-sectional shape. In additional examples, the edges of the metal sheet are attached and form a weld seam at different locations, such as at any location on the upper wall (FIG. 6), the lower wall (FIG. 7), or a side wall (FIG. 5) of the beam.

The crossmember beam 22, as shown in FIG. 4, includes an upper wall 32, a lower wall 34, a first side wall 36, and a second side wall 38 that enclose the hollow body of the beam 20 along the length. The upper and lower walls 32, 34 extend along the top and bottom sides of the first and second hollow sections 24, 26. Similarly, the first side wall 36 extends along the forward-facing side of the beam in the vehicle and the second side wall 38 extends along the opposing rearward-facing side of the beam in the vehicle. Thus, the first side wall 36 extends along and defines a lateral boundary of the first hollow section 24 and the second side wall 38 extends along and defines a lateral boundary of the second hollow section 26. In the example shown in FIG. 4, the planar extent of the upper wall 32 is parallel to the planar extent of the lower wall 34. Also, the planar extent of the upper wall 32 is horizontally aligned across the respective first and second hollow sections 24, 26. Similarly, the planar extent of the lower wall 34 is horizontally aligned across the respective first and second hollow sections 24, 26. Further, the first and second side walls 36, 38 are parallel to each other and perpendicular to the upper and lower walls 32, 34, together forming a generally rectangular exterior cross-sectional shape. It is understood that additional examples may have various differently shaped tubular sections or members, such as to accommodate desired mounting arrangements, such as for different seat assemblies, interior counsels, or the like.

A shown in FIG. 4, the upper and lower walls 32, 34 each include four bends 40 that are formed along the length of the beam 20, which form inward extending wall sections 42 that lead to a recessed wall section 44. The inward extending wall sections 42 are vertically oriented and parallel to the first and second side walls 36, 38. The bends 40 direct and position the upper and lower walls 32, 34 inwards into the interior volume of the beam, so as to generally define the lateral boundaries of the narrowed section 28. More specifically, the narrowed section is defined by the bends 40 that divert the upper and lower walls 32, 34 inwards to form the inward extending wall sections 42. The bends 40, as shown in FIG. 4, are formed to center the recessed wall 44 on the respective upper and lower walls 32, 34, such that the first and second hollow sections 24, 26 are substantially mirror images across the narrowed section 28 of the cross-sectional shape. Moreover, as shown in FIG. 4, the inward extending wall sections 42 are generally equal in length at the upper and lower walls to vertically center the recessed wall 44 in the beam, such that upper and lower halves of the beam are a substantially mirror images across a vertical center of the cross-sectional shape.

As further shown in FIG. 4, the upper wall 32 and the lower wall 34 are in abutting contact and attached together at the narrowed section 28 of the cross-sectional shape. A weld attaches the edges 30 of the metal sheet 22 together. The weld is continuous along the length of the beam. However, in some examples, it is contemplated that some welds may be intermittently disposed along the narrowed section. The edges 30 of the metal sheet 22, as shown in FIG. 4, are abutting and attached at and along the upper wall 32 of the beam 20. The edges 30 of the metal sheet 22 are welded together at a seam extending along the length of the beam, where the seam has a weld, such as an induction weld or high frequency weld, formed continuously between the tips of the edges 30 to align the inner and outer surfaces of the metal sheet 22 on opposing sides of the seam. Such induction or high frequency welding can also improve processing speed and efficiency.

The in some examples, such as shown in FIG. 4, the weld at the edges of the metal sheet 22 may also simultaneously attach the upper and lower walls 32, 34 together. Otherwise, the upper and lower walls may simply be disposed in abutting contact and optionally attached in a secondary process, such with laser or MIG welds intermittently along the length. The attached recessed wall sections 44 of the upper and lower walls 32, 34 are parallel to the planar extents of the upper and lower walls 34, 34 at the first and second hollow sections 24, 26 of the beam. As referred to herein, the meaning of abutting contact means substantially abutting contact, as it is understood that direct contact may not be provided or maintained precisely along the entire length due to manufacturing and material tolerances.

Upon assembly with the floor panel 12, the lower wall 34 of the beam is welded to the metal sheet of the floor panel 12. In additional examples, the recessed wall at the narrowed section may engage a ridge or formation formed in the floor panel, such that the recessed wall may be welded to the ridge or formation in the floor panel. The weld to the floor panel may be formed with intermittent or continuous laser welding or gas metal arc welding or the like. In some examples, the vehicle floor assembly may include a second crossmember attached and spanning between the pair of rocker members at a longitudinally spaced distance from the other crossmember. For example, the front ridge may engage or be replaced with a crossmember. With the use of two crossmembers, the crossmembers may be used and configured to support front and rear mounting locations of a seat assembly.

Referring now to FIGS. 5-13, additional examples of structural beams or crossmember are provided with different cross-sectional shape. Like reference numbers are provided at like features to those described above, incremented by one hundred for each example.

As shown in FIG. 5, the crossmember 120 is a roll-formed beam having an elongated hollow body formed from a metal sheet 122 that has a cross-sectional shape with the first hollow section 124 has a larger interior volume than the second hollow section 126. The planar extent of the lower wall 134 is aligned across the respective first and second hollow sections 124, 126, and as shown in FIG. 5, is angled relative to the planar extent of the upper wall 132. Also, the planar extent of the upper wall 132 is aligned across the respective first and second hollow sections 124, 126. The angled offset of the upper and lower walls 132, 134 is approximately 15 degrees or approximately less than 45 degrees. The angled offset allows the bottom surface of the lower wall 134 to be attached to an angled portion of the floor panel and/or the top surface of the upper wall 132 to be attached to angled portion of a seat assembly.

As also shown in FIG. 5, the first side wall 136 has a weld that attaches the edges 130 of the metal sheet 122 together. The weld is continuous along the length of the beam 120. The edges 130 of the metal sheet 122, as shown in FIG. 5, are abutting and attached at and along the side wall 136 of the beam 120. The edges 130 of the metal sheet 122 are welded together at a seam extending along the length of the beam, where the seam has an induction weld formed continuously between the tips of the edges 130 to align the inner and outer surfaces of the metal sheet 122 on opposing sides of the seam.

As further shown in FIG. 5, the first and second side walls 136, 138 are parallel to each other and perpendicular to the upper wall 132, where the first side wall 136 is longer than the second side wall 138 due to the angled offset of the lower wall 134 relative to the upper wall 132, together forming a generally wedge-shaped exterior cross-sectional shape. The lower wall 134 shown in FIG. 5 also has four bends 140 that form a recessed wall section 144 along the length of the beam 120. The bends 140 on the lower wall 134 immediately follow each other, so as to omit any vertically oriented inward extending wall sections there between.

As shown in FIG. 6, the crossmember 220 is a roll-formed beam having an elongated hollow body formed from a metal sheet 222 that has a cross-sectional shape with the first hollow section 224 and the second hollow section 226 each including a stiffening channel 246 disposed along the length of the beam 220. The stiffening channels 246 are each formed in the side walls 236, 238 and are vertically centered on each side wall. The stiffening channels 246 are substantially rounded and function to stiffen the corresponding side wall.

As also shown in FIG. 6, the weld that attaches the edges 130 of the metal sheet 122 together is formed along the upper wall 232 at the second hollow section 226. The weld is continuous along the length of the beam 220. The edges 230 of the metal sheet 222, as shown in FIG. 6, are abutting and attached at and along the upper wall 232 of the beam 220. The edges 230 of the metal sheet 222 are welded together at a seam extending along the length of the beam, where the seam has an induction weld formed continuously between the tips of the edges 230 to align the inner and outer surfaces of the metal sheet 222 on opposing sides of the seam.

As shown in FIG. 7, the crossmember 320 is a roll-formed beam having an elongated hollow body formed from a metal sheet 322 that has a cross-sectional shape with the first hollow section 324 and the second hollow section 326 each including two stiffening channels 346 disposed along the length of the beam 320. The stiffening channels 346 are formed in the upper and lower walls 332, 334 and are horizontally centered on each of the first and second hollow sections 324, 326. The stiffening channels 346 are substantially rounded and function to stiffen the corresponding upper and lower walls.

As further shown in FIG. 7, the upper wall 332 and the lower wall 334 are in abutting contact and attached together at the narrowed section 328 of the cross-sectional shape. The edges 330 of the metal sheet 322, as shown in FIG. 7, are abutting and attached at and along the lower wall 334 of the beam 320. The weld attaches the edges 330 of the metal sheet 322 together and simultaneously attaches the upper and lower walls 332, 334 together. The weld is continuous along the length of the beam. The attached recessed wall sections 344 of the upper and lower walls 332, 334 are parallel to the planar extents of the upper and lower walls 332, 334 at the first and second hollow sections 324, 326 of the beam.

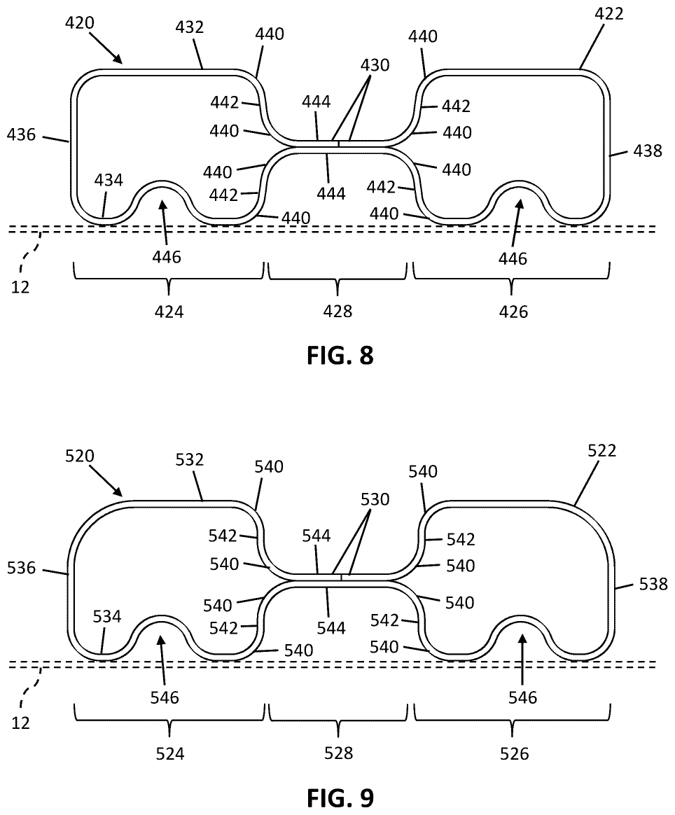

As shown in FIG. 8, the crossmember 420 is a roll-formed beam having an elongated hollow body formed from a metal sheet 422 that has a cross-sectional shape with the first hollow section 424 and the second hollow section 426 each including a stiffening channel 346 disposed along the length of the beam 420. The stiffening channels 446 are formed in the lower walls 434 and are horizontally centered on each of the first and second hollow sections 424, 426. The stiffening channels 446 are substantially rounded and function to stiffen the corresponding walls. The example of the crossmember 520 shown in FIG. 9 is substantially the same as that shown in FIG. 8 with the exception of the corners between the side walls 536, 538 and the upper wall 532 having a larger radius of curvature that reduces the interior volumes of the each of the hollow sections 524, 526 of the beam.

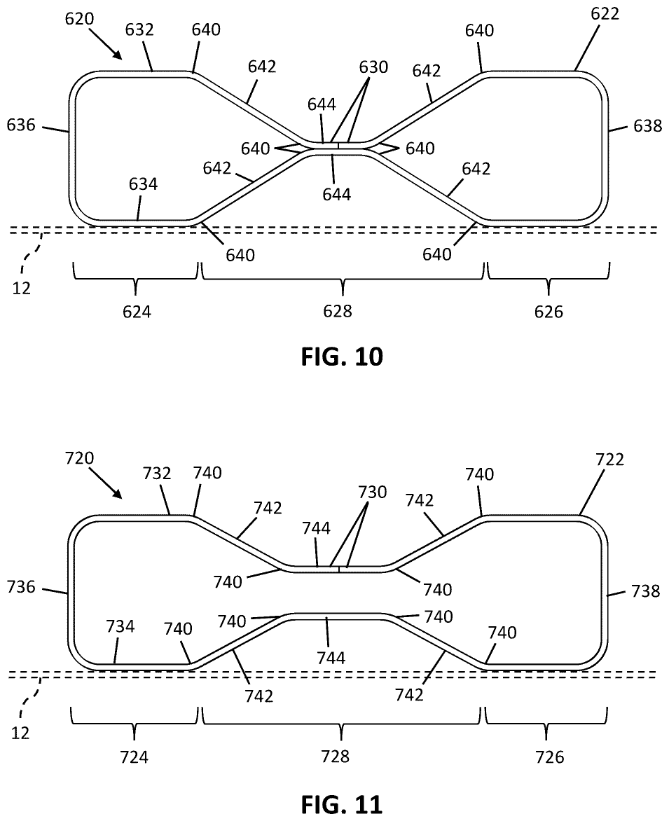

As shown in FIG. 10, the crossmember 620 is a roll-formed beam having an elongated hollow body formed from a metal sheet 622. The first and second hollow sections 624, 626 are interconnected by a narrowed section 628 of the cross-sectional shape. The upper and lower walls 632, 634 each include four bends 640 that are formed along the length of the beam 620. The inward extending wall sections 642 that lead to the abutting recessed wall sections 644 are angled at approximately 45 degrees relative to the recessed wall section 644, such that cross-sectional shape forms a generally hourglass shape. The uppermost and lowermost bends 640 between the inward extending wall sections 642 and the top and bottom horizontal sections of the upper and lower walls generally define the lateral boundaries of the narrowed section 628. More specifically, the narrowed section is defined by the bends 640 that divert the upper and lower walls 632, 634 inwards to form the inward extending wall sections 642. The bends 640, as shown in FIG. 10, are formed to center the recessed wall 644 on the respective upper and lower walls 632, 634, such that the first and second hollow sections 624, 626 are substantially mirror images across the narrowed section 628 of the cross-sectional shape. Moreover, as shown in FIG. 10, the inward extending wall sections 642 are generally equal in length at the upper and lower walls to vertically center the recessed wall 644 in the beam, such that upper and lower halves of the beam are a substantially mirror images across a vertical center of the cross-sectional shape.

As shown in FIG. 11, the crossmember 720 is substantially similar to the crossmember 620 shown in FIG. 10 with the inward extending wall sections 742 that lead to the recessed wall sections 744 being angled at approximately 45 degrees relative to the recessed wall sections 744. However, the recessed wall sections 742 have a shorter length, such that the upper wall 732 and the lower wall 734 are spaced apart at the narrowed section 728 of the cross-sectional shape. While spaced apart, the recessed wall section 742 are disposed in closer proximity than the upper-most and lower-most horizontal sections of the upper and lower walls 732, 734 at the first and second hollow sections 724, 726 of the beam. A weld attaches the edges 730 of the metal sheet 722 together at the upper wall 732, but does not attach the upper and lower walls 732, 734 together. The recessed wall sections 744 of the upper and lower walls 732, 734 are parallel to each other and the planar extents of the upper and lower walls 734, 734 at the first and second hollow sections 724, 726 of the beam. Also, in additional examples, the butt weld joint along the edges of the sheet may be a lap weld joint configuration.

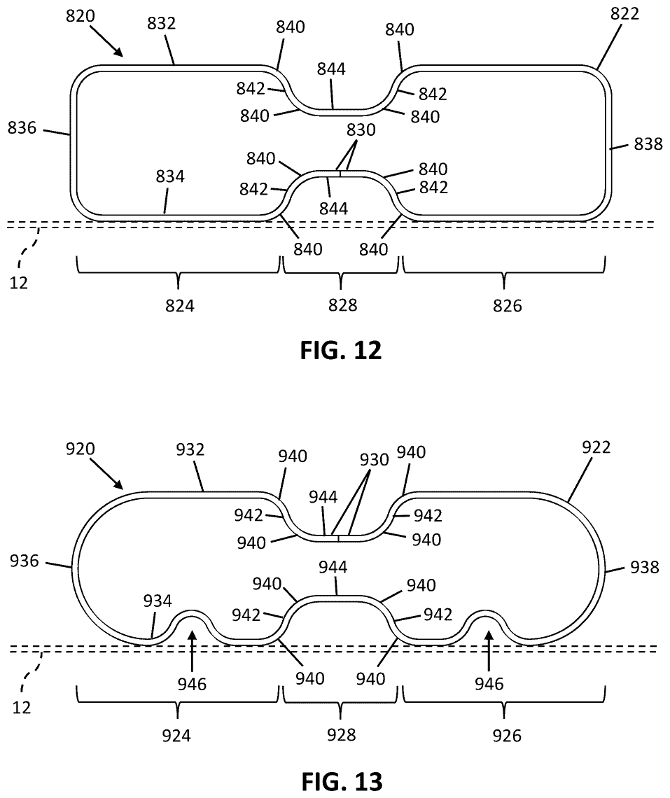

As shown in FIG. 12, the crossmember 820 is substantially similar to the crossmember 720 shown in FIG. 11, but with the inward extending wall sections 842 that lead to the recessed wall sections 844 being angled at a greater angle relative to the recessed wall sections 844, such as greater than 45 degrees or between 55 and 80 degrees or approximately 75 degrees. The recessed wall sections 844 shown in FIG. 12 are also spaced apart from each other a greater distance than the crossmember 720 shown in FIG. 11. Further, the edges 830 of the metal sheet 822, as shown in FIG. 12, are abutting and attached at and along the lower wall 834 of the beam 820.

As shown in FIG. 13, the crossmember 920 is substantially similar to the crossmember 820 shown in FIG. 12, including the narrowed section 928 and corresponding inward extending wall sections 942 and recessed wall sections 944. However, the first and second side walls 936, 938 of the crossmember 920 are rounded with a curvature that extends between the upper and lower walls 932, 934. The curved shape of the side walls 936, 938 adds additional stiffness to the side walls. Also, the lower wall 934 of the crossmember 920 includes stiffening channels 946, namely a single stiffening channel 946 disposed at the first hollow section 924 and the second hollow section 926. The stiffening channels 946 formed in the lower walls 934 are horizontally centered on each of the first and second hollow sections 924, 926. The stiffening channels 946 are each substantially rounded and function to stiffen the corresponding sections of the lower wall.

The crossmember may be made from a sheet of steel material having a thickness of 0.8 mm to 1.4 mm or approximately between 1 mm and 1.5 mm. Also, the sheet may have a tensile strength of about 800 to 2000 MPa (i.e. about 120 to 290 ksi), such as at least 980 MPa or at least 1,500 MPa. In additional implementations the reinforcement beam can be made of different materials, including AHSS (Advanced High Strength Steels) and it can be made from a sheet having a thickness of about 0.8 mm to 3.0 mm thick. Alternatively, the metal sheet may be a high strength aluminum sheet.

Also, the crossmembers may include mounting features at desirable locations for mounting a seat assembly or other vehicle components or sub-assemblies. The mounting features may include holes or attachment features (e.g., SPAC nuts, riv nuts, or the like) at selection locations on the top walls to provide similar attachment locations.

For purposes of this disclosure, the term “coupled” (in all of its forms, couple, coupling, coupled, etc.) generally means the joining of two components directly or indirectly to one another. Such joining may be stationary in nature or movable in nature; may be achieved with the two components and any additional intermediate members being integrally formed as a single unitary body with one another or with the two components; and may be permanent in nature or may be removable or releasable in nature, unless otherwise stated.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” “inboard,” “outboard” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A crossmember for a vehicle floor structure, the crossmember comprising:
a roll-formed beam having an elongated hollow body formed from a metal sheet and configured to span laterally over a floor panel,
wherein the beam comprises a cross-sectional shape taken transverse to a length of the beam and extending consistently along the length between opposing ends of the beam,
wherein the beam comprises a first hollow section and a second hollow section extending along the length of the beam, the first and second hollow sections interconnected by a narrowed section of the cross-sectional shape, and
wherein edges of the metal sheet are welded together along the length of the beam at the narrowed section of the cross-sectional shape.

2. The crossmember of claim 1, wherein the beam comprises an upper wall and a lower wall extending along opposing sides of the first and second hollow sections.

3. The crossmember of claim 2, wherein the upper and lower walls each include at least two bends along the length of the beam that direct the respective upper and lower walls inward at the narrowed section.

4. The crossmember of claim 2, wherein the upper wall and the lower wall are attached at the narrowed section of the cross-sectional shape.

5. The crossmember of claim 4, wherein a weld attaching the edges of the metal sheet together simultaneously welds the upper and lower walls together.

6. The crossmember of claim 2, wherein the upper wall and the lower wall are spaced apart at the narrowed section of the cross-sectional shape.

7. The crossmember of claim 2, wherein the edges of the metal sheet are attached at the upper wall or the lower wall of the beam.

8. A vehicle floor assembly comprising:
a floor panel; and
a crossmember beam disposed at and extending over an upper surface of the floor panel,
wherein the crossmember beam comprises an elongated hollow body formed from a metal sheet and defining a cross-sectional shape that extends continuously along a linear length of the crossmember beam,
wherein the crossmember beam comprises a first hollow section and a second hollow section extending adjacent to each other along the linear length of the crossmember beam,
wherein the first and second hollow sections are interconnected by a narrowed section of the cross-sectional shape, and
wherein edges of the metal sheet are welded together along the linear length of the crossmember beam at the narrowed section of the cross-sectional shape.

9. The vehicle floor assembly of claim 8, wherein the metal sheet of the crossmember beam comprises a martensitic steel with a tensile strength of at least 980 MPa.

10. The vehicle floor assembly of claim 8, further comprising a pair of rocker sections extending longitudinally along outboard edges of the floor panel, wherein the crossmember beam extends laterally across the floor panel between the pair of rocker sections, and wherein the crossmember beam defines a lateral load path between the pair of rocker sections.

11. The vehicle floor assembly of claim 10, further comprising:
a second crossmember attached and spanning between the pair of rocker sections at a longitudinally spaced distance from the crossmember that is configured to accommodate a seat assembly that is coupled at and supported by the first and second crossmembers.

12. The vehicle floor assembly of claim 8, wherein the crossmember beam comprises an upper wall and a lower wall extending along opposing sides of the first and second hollow sections.

13. The vehicle floor assembly of claim 12, wherein the upper wall and the lower wall are attached at the narrowed section of the cross-sectional shape, wherein a weld attaching the edges of the metal sheet together simultaneously welds the upper and lower walls together.

14. The vehicle floor assembly of claim 12, wherein the edges of the metal sheet are attached at the upper wall or the lower wall of the crossmember beam.

15. The vehicle floor assembly of claim 12, wherein at least one of the first and second hollow sections includes a stiffening channel disposed along the linear length of the crossmember beam.

16. The vehicle floor assembly of claim 12, wherein the first and second hollow sections of the crossmember beam are substantially mirror images across the narrowed section of the cross-sectional shape.

17. The vehicle floor assembly of claim 12, wherein an upper planar portion of the upper wall at the first and second hollow sections is angled relative to a lower planar portion of the lower wall at the first and second hollow sections.

18. A crossmember for a vehicle floor structure, the crossmember comprising:
a roll-formed beam having an elongated hollow body formed from a metal sheet and configured to span laterally over a floor panel,
wherein the beam comprises a cross-sectional shape taken transverse to a length of the beam and extending consistently along the length between opposing ends of the beam,
wherein the beam comprises a first hollow section and a second hollow section extending along the length of the beam, the first and second hollow sections interconnected by a narrowed section of the cross-sectional shape, and
wherein edges of the metal sheet are welded together at a seam extending along the length of the beam, the seam having an induction weld formed continuously between the edges to align the inner and outer surfaces of the metal sheet on opposing sides of the seam.

19. The crossmember of claim 18, wherein the beam comprises an upper wall and a lower wall extending along opposing sides of the first and second hollow sections, and wherein the upper and lower walls each include at least two bends along the length of the beam that direct the respective upper and lower walls inward at the narrowed section.

20. The crossmember of claim 19, wherein the edges of the metal sheet are attached and form the seam at the upper wall, the lower wall, or a side wall of the beam that extends between the upper and lower walls.
